(19) United States
(12) Patent Application Publication
(10) Pub. No.: US 2017/0340168 A1
(43) Pub. Date: Nov. 30, 2017

(54) AIR VENT CONTROLS FOR GRILLS

(71) Applicant: Phase 2, LLC, St. Louis, MO (US)

(72) Inventor: Jon Scott WALTERS, St. Louis, MO (US)

(21) Appl. No.: 15/610,129

(22) Filed: May 31, 2017

Related U.S. Application Data
(60) Provisional application No. 62/343,521, filed on May 31, 2016.
(60) Provisional application No. 62/459,282, filed on Feb. 15, 2017.

(51) Int. Cl. A47J 37/07

(52) U.S. Cl. CPC A47J 37/0786

(57) ABSTRACT

A grill assembly includes a cooking chamber, and a first vent and a second each having a plurality of vent settings. Each vent setting of the first vent corresponds to a different level of airflow in the cooking chamber, and each vent setting of the second vent corresponds to a different level of airflow in the cooking chamber. Each vent setting of the first vent is designated with a color, and each vent setting of the second vent is designated with a color. The assembly is adapted for one cooking configuration in response to the vent setting of the first vent and the vent setting of the second vent having a matching color, and another cooking configuration in response to the vent setting of the first vent and the vent setting of the second vent having another matching color. Other example vents, grill assemblies, etc. are also disclosed.

### CROSS-REFERENCE TO RELATED APPLICATIONS

This application claims the benefit of U.S. Provisional Application No. 62/343,521 filed May 31, 2016 and U.S. Provisional Application No. 62/459,282 filed Feb. 15, 2017. The entire disclosures of the above applications are incorporated herein by reference.

### FIELD

The present disclosure relates to air vent controls for grills.

### BACKGROUND

This section provides background information related to the present disclosure which is not necessarily prior art.

Grills include different components for cooking various types of food. Additionally, grills may cook food by various different methods. For example, grills commonly use direct heat from burning charcoal or propane to grill food. Other grills can use smoke from charcoal, wood, etc. to cook food.

### SUMMARY

This section provides a general summary of the disclosure, and is not a comprehensive disclosure of its full scope or all of its features.

According to one aspect of the present disclosure, a grill assembly includes a cooking chamber, a first vent having a plurality of vent settings, and a second vent having a plurality of vent settings. Each vent setting of the first vent corresponds to a different level of airflow in the cooking chamber, and each vent setting of the second vent corresponds to a different level of airflow in the cooking chamber. Each vent setting of the first vent is designated with a color, and each vent setting of the second vent is designated with a color. The grill assembly is adapted for one cooking configuration in response to the vent setting of the first vent and the vent setting of the second vent having a matching color, and another cooking configuration in response to the vent setting of the first vent and the vent setting of the second vent having another matching color.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a grill including vents each having vent settings for different cooking configurations, according to one example embodiment of the present disclosure.

FIG. 2 is a front view of a kamado-style grill including two vents each having vent settings for different cooking configurations, according to another example embodiment.

FIG. 3 is a front view of one of the vents of the kamado-style grill of FIG. 2.

FIG. 4 is a front view of the other vent of the kamado-style grill of FIG. 2.

FIG. 5A is a front view of a label for the vent of FIG. 3, in which the label includes the vent settings according to yet another example embodiment.

FIG. 5B is the back view of the label of FIG. 5A.

FIG. 6A is a front view of a removable unit including a vent having vent settings for different cooking configurations, where the vent is set to a searing configuration, according to another example embodiment.

FIG. 6B is a front view of the removable unit of FIG. 6A, but with the vent set to a grilling configuration.

FIG. 6C is a front view of the removable unit of FIG. 6A, but with the vent set to a smoking configuration.

FIG. 7 is a perspective view of a removable unit including a vent having vent settings for different cooking configurations according to yet another example embodiment.

FIG. 8 is a perspective view of a removable unit similar to the removable unit of FIG. 7, but including a port for receiving a fire starter device according to another example embodiment.

FIG. 9 is a front view of a removable unit including a vent having two rotatable vent covers according to yet another example embodiment.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

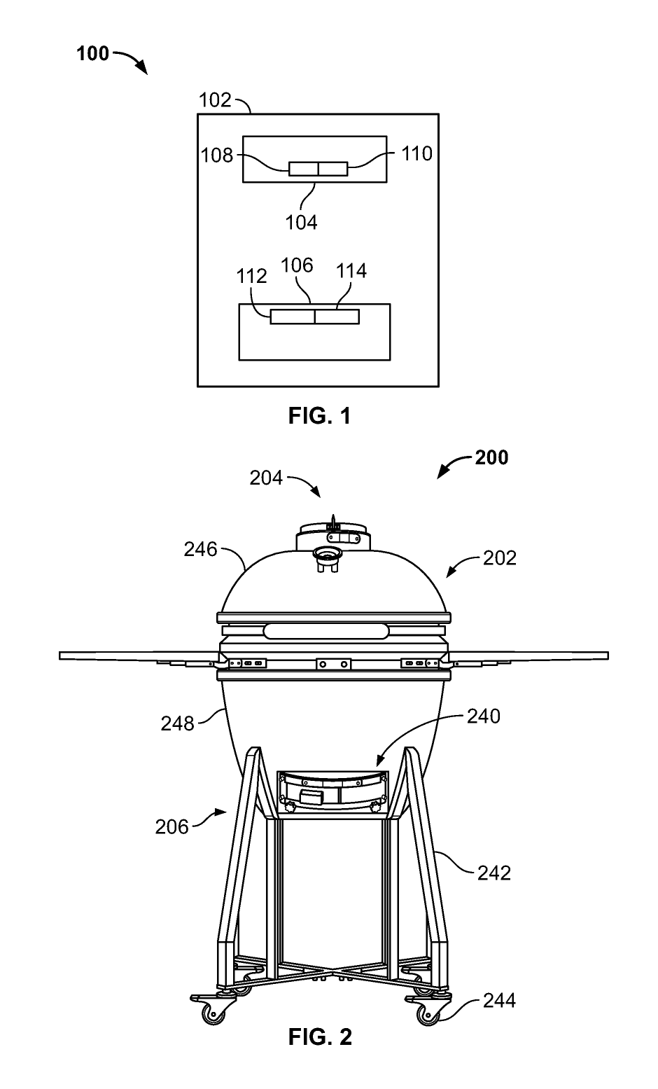

A grill according to one example embodiment of the present disclosure is illustrated in FIG. 1 and indicated generally by reference number 100. As shown in FIG. 1, the grill 100 includes a cooking chamber 102 and vents 104, 106. The vent 104 has vent settings 108, 110 corresponding to a different level of airflow in the cooking chamber 102, and the vent 106 has vent settings 112, 114 corresponding to a different level of airflow in the cooking chamber 102. Each vent setting 108, 110 is designated with a color, and each vent setting 112, 114 is designated with a color. The grill 100 is adapted for one cooking configuration in response to the vent setting of the vent 104 and the vent setting of the vent 106 having a matching color and another cooking configuration in response to the vent setting of the vent 104 and the vent setting of the vent 106 having another matching color.

For example, the vent settings 108, 110 may be designated with different colors (e.g., yellow and red, respectively). Likewise, the vent settings 112, 114 may be designated with different colors (e.g., yellow and red, respectively). In this example, when the vent setting 108 designated with the color yellow is selected and the vent setting 112 designated with the color yellow is selected, the grill 100 is configured for a particular cooking configuration. If the vent setting 110 designated with the color red is later selected and the vent setting 114 designated with the color red is later selected, the grill 100 can be configured for a different cooking configuration.

The cooking configurations correspond to different amounts of airflow in the cooking chamber 102. For example, the vents 104, 106 may be manipulated to select different vent settings 108, 110, 112, 114. The vent settings 108, 110, 112, 114 correspond to a different level of air flowing through vent opening(s) of one of the vents (e.g., the vent 106), through the cooking chamber 102, and through vent opening(s) of the other vent (e.g., the vent 104). As such, particular vent settings 108, 110, 112, 114 may be selected to achieve a desired level of airflow in the cooking chamber 102.

The level of airflow in the cooking chamber 102 may be conducive to one particular cooking configuration. For example, one level of airflow in the cooking chamber 102 may cause a temperature within the grill 100 to substantially regulate at a temperature conducive to one cooking configuration (e.g., smoking, etc.). Additionally, another level of airflow in the cooking chamber 102 may cause a temperature within the grill 100 to substantially regulate at a different temperature conducive for another cooking configuration (e.g., searing, etc.). Therefore, by employing the vents 104, 106 (and/or other vents disclosed herein) having designated color coded vent settings 108, 110, 112, 114 which adapt the grill 100 to different cooking configurations, a user can easily and quickly change the amount of airflow in the cooking chamber 102. As a result, the temperature within the grill 100 can be controlled to meet temperature specifications of different cooking configurations.

The cooking configurations disclosed herein can include various different configurations (e.g. methods of cooking, etc.) including, for example, smoking, grilling, baking, searing, steaming, and/or other suitable cooking methods. In the particular example of FIG. 1, the cooking configurations can include at least one of a smoking configuration, a grilling configuration and a searing configuration. As such, when one of the vent settings 108, 110 and one of the vent settings 112, 114 are selected to have a matching color, the grill 100 can be adapted for at least one of a smoking configuration, a grilling configuration and a searing configuration. For example, the grill 100 can be adapted for a smoking configuration and a grilling configuration, a smoking configuration and a searing configuration, a grilling configuration and a searing configuration, etc.

As explained above, the vent 104 and the vent 106 of FIG. 1 each include two vent settings 108, 110, 112, 114. The colors used to designate the vent settings 108, 110 of the vent 104 and the vent settings 112, 114 of the vent 106 may be any suitable color. For example, the vent settings 108, 110 may be designated with the colors red and orange, respectively, and the vent settings 112, 114 may be designated with the colors red and orange, respectively. In other embodiments, the vent settings 108, 110 may be designated with the colors blue and yellow, respectively, and the vent settings 112, 114 may be designated with the colors yellow and blue, respectively.

The vent settings 108, 110 of the vent 104 and/or the vent settings 112, 114 of the vent 106 may be represented by a range of positions. For example, the vent setting 108 may have a range of positions within the particular color used to designate that vent setting 108. The range of positions can be an analog scale of positions within the color, multiple discrete positions within the color, etc. This range of positions within the vent setting 108 (and/or any other vent setting disclosed herein) allows a user to provide fine adjustments to the level of airflow in the cooking chamber 102 while remaining in the same cooking configuration. As a result, the temperature within the grill 100 may be adjusted, as explained above. For example, and as further explained below, the positions within a vent setting may correspond to different sizes of the vent opening(s), different amounts of vent openings closed/opened to allow air to pass through, etc.

In other embodiments, the vent settings 108, 110 and/or the vent settings 112, 114 may each have one discrete selectable position that corresponds to a particular level of airflow in the cooking chamber 102.

The cooking chamber 102 of FIG. 1 may include various optional features. For example, the cooking chamber 102 may include one or more temperature sensors, grates for supporting food, charcoal and/or another fuel to generate heat, etc. In some embodiments, the cooking chamber 102 may include one or more containers. For example, the cooking chamber 102 may include a vessel and a fire bowl disposed within the vessel, as further explained below.

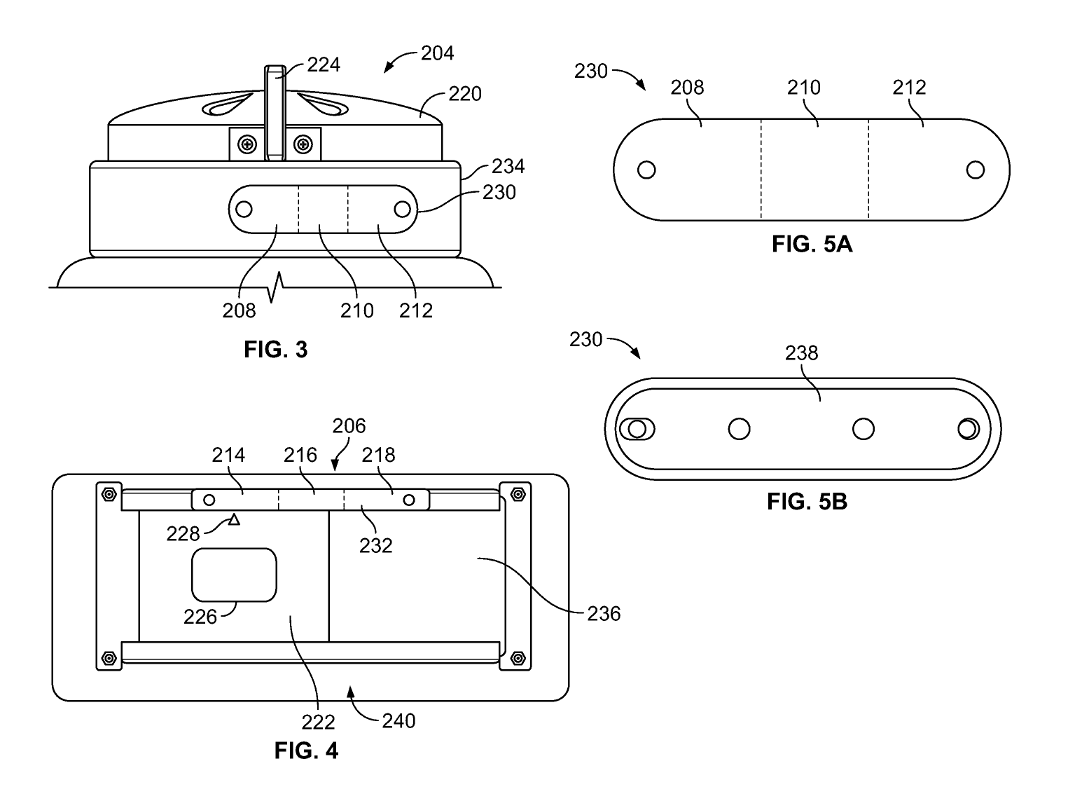

FIG. 2 illustrates another grill 200 substantially similar to the grill 100. For example, the grill 200 includes a cooking chamber 202 and vents 204, 206 similar to the cooking chamber 102 and vents 104, 106 of FIG. 1. As shown in FIGS. 2 and 3, the vent 204 includes vent settings 208, 210, 212 corresponding to a different level of airflow in the cooking chamber 202. Additionally, and as shown in FIGS. 2 and 4, the vent 206 includes vent settings 214, 216, 218 corresponding to a different level of airflow in the cooking chamber 202. The vent settings 208, 210, 212, 214, 216, 218 of FIG. 2 are substantially similar to the vent settings 108, 110, 112, 114 of FIG. 1.

As shown, the vent settings 208, 210, 212 of the vent 204 are designated with the colors yellow, orange and red, respectively, and the vent settings 214, 216, 218 of the vent 206 are designated with the colors yellow, orange and red, respectively. Dashed lines are shown to delineate the different vent settings 208, 210, 212, 214, 216, 218.

When one of the vent settings 208, 210, 212 of the vent 204 and one of the vent settings 214, 216, 218 of the vent 206 have a matching color, the grill 200 is adapted for a particular cooking configuration, as explained above. As such, because the vent settings 208, 210, 212 and the settings 214, 216, 218 each have three different colors (e.g., yellow, orange and red), the grill 200 can be adapted for three different cooking configurations. For example, the grill 200 can be adapted for a smoking configuration, a grilling configuration and a searing configuration, as explained above.

As shown in FIG. 2, the vents 204, 206 are positioned on opposing sides of the grill 200. For example, the vent 204 is positioned adjacent to a top side of the grill 200 and the vent 206 is positioned adjacent to a bottom side of the grill 200. In other embodiments, the vents 204, 206 may be positioned at other suitable location if desired.

As shown in FIGS. 3 and 4, the vents 204, 206 each include a vent cover 220, 222 movable relative to one or more openings (e.g. sometimes referred to as vent openings) in the vents to adjust the amount of air flowing through the opening(s). For example, the vents 204, 206 include bases 234, 236, respectively. One or both vent covers 220, 222 of the vents 204, 206 may move relative to the bases 234, 236 to adjust the size of the opening(s), the number of opening(s) allowing air to pass through, etc. In the particular example of FIGS. 2-4, the vent cover 220 of the vent 204 is rotatable about a center axis, and the vent cover 222 of the vent 206 is slidable in a horizontal direction. Alternatively, other suitable ways of moving one or both vent covers 220, 222 may be employed without departing from the scope of the disclosure. For example, the vent 206 may include one or more rotatable vent covers.

One or both vent covers 220, 222 may be moved to change which particular vent settings 208, 210, 212, 214, 216, 218 is selected. For example, the vent cover 220 may be rotated to select one of the vent settings 208, 210, 212, and the vent cover 222 may be moved to select one of the vent settings 214, 216, 218. Therefore, the vent covers 220, 222 can be moved such that the current vent settings selected (e.g., the vent settings 208, 214 in FIGS. 3 and 4) corresponding to one cooking configuration can be changed to other vent settings (e.g., the vent settings 212, 218) corresponding to another cooking configuration, as explained herein.

In some embodiments, at least one of the vents 204, 206 may include a device coupled to its vent cover 220, 222 to assist a user in moving (e.g. sliding, rotating, etc.) the vent cover 220, 222 between the different vent settings. In the particular example of FIGS. 2-4, the vent 204 includes a knob 224 extending from the vent cover 220 and the vent 206 includes a knob 226 extending from the vent cover 222. As such, a user may grasp, push, pull, etc. one or both knobs 224, 226 to move the vent covers 220, 222 thereby selecting different vent settings, as explained above.

As shown in FIGS. 2-4, the knob 224 is triangular and the knob 226 is rectangular. Alternatively, one or both knobs 224, 226 may be another suitable shape including, for example, circular, crescent, etc.

In some embodiments, one or both vents covers 220, 222 may include one or more indicators to notify a user which vent setting is selected. For example, and as shown in FIG. 4, the vents cover 222 includes an indicator 228 adjacent to the vent setting 214. In some examples, one or both indicators may be its corresponding knob 224, 226. For example, and as shown in FIG. 3, the knob 224 acts as the indicator for the vent 204.

One or more of the vent settings of the vents 204, 206 may be designated with one or more symbols. For example, and as shown best in FIGS. 3 and 4, the vent settings 208, 210, 212, 214, 216, 218 each are designated with a symbol. In this particular example, the symbols are words. For example, the vent settings 208, 210, 212 are designated with the words “SMOKE”, “GRILL” and “SEAR,” respectively, and the settings 214, 216, 218 are designated with the words “SMOKE”, “GRILL” and “SEAR,” respectively. The different words correspond to different cooking configurations (e.g., the smoking configuration, the grilling configuration, and the searing configuration), as explained above.

In some embodiments, additional and/or alternative words may be used. For example, the words “High”, “Medium”, “Low”, etc. may be employed if desired. In other embodiments, the symbols may include one or more shapes (e.g., flames, etc.), numbers, and/or any other suitable indicia.

As shown in FIGS. 2-5, the vents 204, 206 each include a label 230, 232 coupled to the base 234, 236, respectively. The labels 230, 232 include the vent settings of the vents 204, 206. For example, and as shown in FIGS. 3-5, the vent settings 208, 210, 212 of the vent 204 are positioned on the label 230 and the vent settings 214, 216, 218 of the vent 206 are positioned on the label 232.

The labels 230, 232 may be coupled to the bases 234, 236 via one or more mechanical fasteners (e.g., screws, clamps, bolts, nuts, rivets, etc.), adhesives, etc. In the particular example of FIGS. 2-4, the labels 230, 232 are coupled to the bases 234, 236 via rivets. In other embodiments, the labels 230, 232 may be painted on the bases 234, 236.

The label 230 of the vent 204 and the label 232 of the vent 206 may be substantially the same. For example, both labels 230, 232 may be formed of similar material(s), etc. Preferably, the labels 230, 232 are formed of one or more materials that can withstand high temperatures (e.g., about 300° F., etc.) such that the labels 230, 232 do not warp and/or otherwise become deformed when exposed to heat. In the particular example of FIGS. 2-5, the labels 230, 232 are formed at least partially of rubber such as, for example, silicone rubber, etc. In other embodiments, the labels 230, 232 may be formed of different material(s), have different dimensions, etc.

In some embodiments, one or both labels 230, 232 may include an inlay to provide added strength, thermal resistance, thermal spreading, etc. For example, and as shown in FIG. 5B, the label 230 includes an inlay 238 positioned on the backside of the label 230. As such, when the label 230 is coupled to the base 234, the inlay 238 is positioned against the base 234. The inlay 238 may be formed of one or more metals (e.g., aluminum, steel, etc.) and/or another suitable material.

In some embodiments, one or both vents 204, 206 may be part of a removable unit and/or a fixed unit. For example, the grill 200 includes a removable unit 240 that may be inserted into the cooking chamber 202 (as shown in FIGS. 2 and 4) and/or removed from the grill 200. In particular, the removable unit 240 may be inserted through an opening in the cooking chamber 202. As shown, the removable unit 240 includes the vent 206. In other embodiments, the vent 206 (and/or at least portions of the vent 206) may be separate from the removable unit 240. As further explained below, the removable unit 240 and/or other units disclosed herein may include various optional features including, for example, one or more ash receptacles, fire starter openings, user input controls, vent covers, etc.

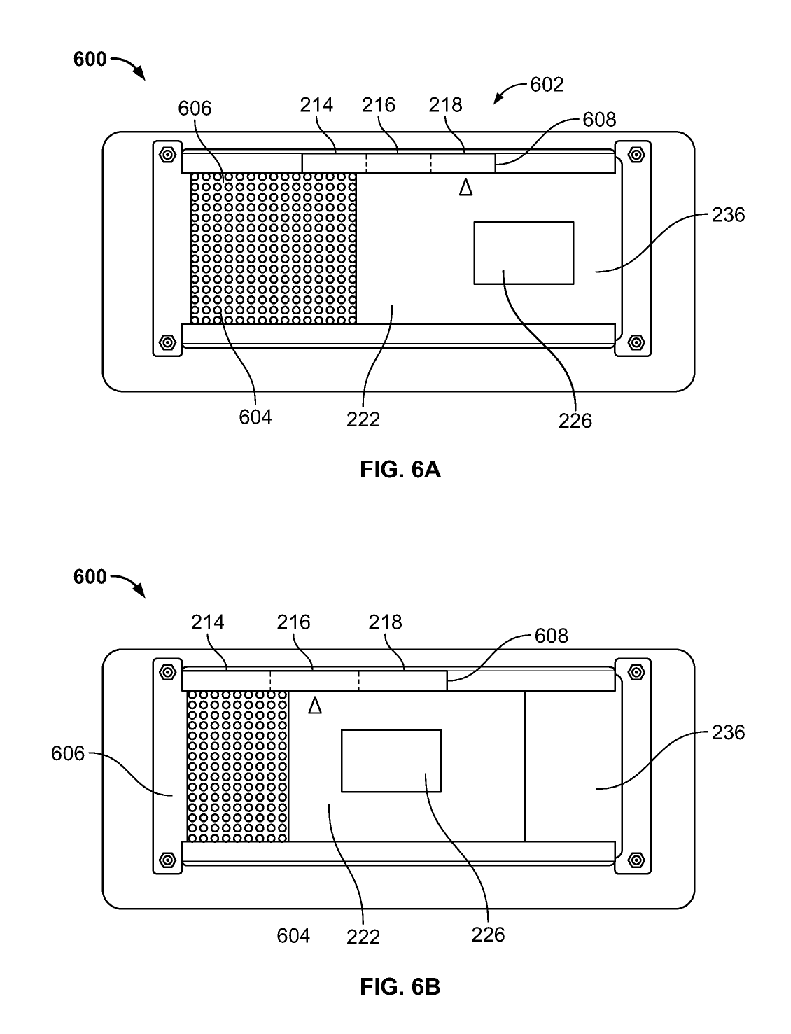

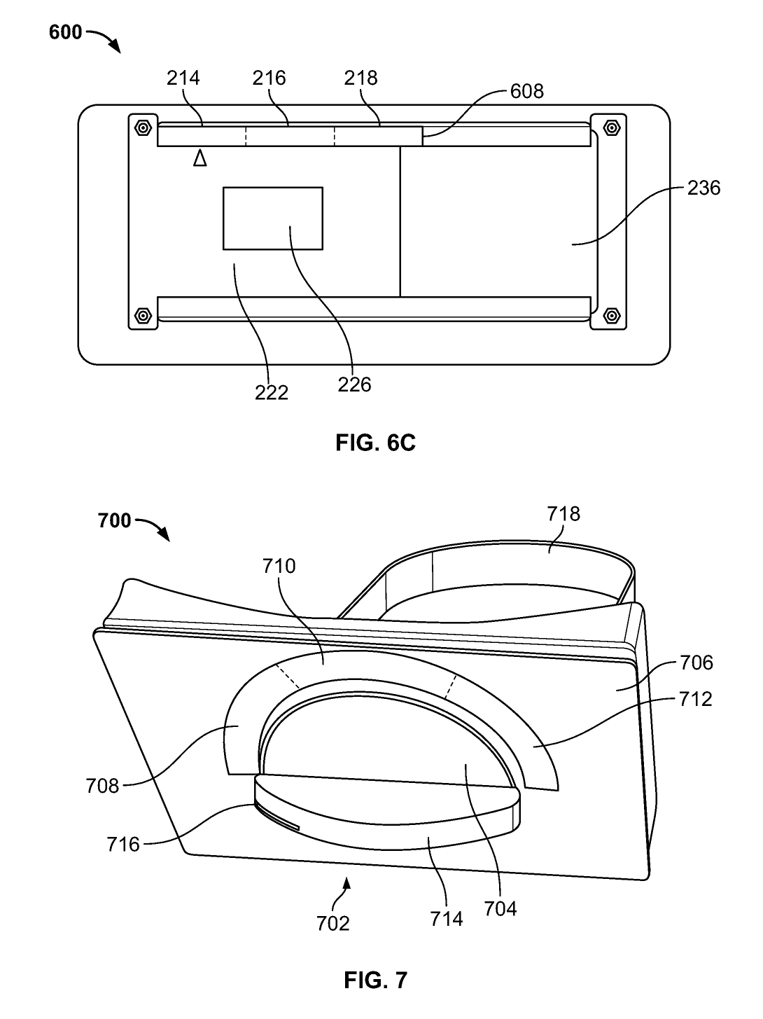

FIGS. 6A, 6B and 6C (collectively FIG. 6) illustrate another removable unit 600 employable in a grill including any of the grills disclosed herein. The removable unit 600 of FIG. 6 is substantially similar to the removable unit 240 of FIGS. 2 and 4. For example, and as shown, the removable unit 600 includes a vent 602 having the base 236, the vent cover 222 and the knob 226. The vent cover 222 is movable relative to vent opening(s) 604, as explained above. In the particular example of FIG. 6, the vent opening(s) 604 are defined by the vent 602. For example, the vent 602 includes a plate 606 defining the vent opening(s) 604.

The vent 602 may include any suitable number and/or configuration of vent opening(s) 604. For example, the vent 602 may include more or less than two hundred vent openings 604 arranged in a substantial rectangular pattern, more or less than four hundred vent openings 604 arranged in a substantial oval pattern, etc. Additionally, the vent openings 604 may be any suitable size depending on for example, airflow/temperature control, the size of the grill employing the removable unit 600, etc.

As shown in FIG. 6, the vent 602 includes a label 608 substantially similar to the label 232 of FIG. 4. For example, the label 608 includes the three vent settings 214, 216, 218 of FIG. 4. In the particular example of FIG. 6, the label 608 is adhered to the base 236.

The vent cover 222 is movable to select different vent settings 214, 216, 218 of the vent 602 such that a grill including the removable unit 600 can be adapted for different cooking configurations, as explained above. For example, FIG. 6C shows the vent 602 set at the vent setting 214 (e.g., the smoking configuration) with a substantial portion, and sometimes all, of the vent openings 604 covered by the vent cover 222 to substantially restrict the amount of air passing through the vent 602. FIG. 6B shows the vent 602 set at the vent setting 216 (e.g., the grilling configuration) with a portion of the vent openings 604 covered by the vent cover 222. Likewise, FIG. 6A shows the vent 602 set at the vent setting 218 (e.g., the searing configuration) with a substantial portion, and sometimes all, of the vent openings 604 exposed to allow more air to pass through the vent 602, compared to the grilling configuration and the smoking configuration.

As explained above, one or more vent covers may be rotatable. For example, FIG. 7 illustrates another removable unit 700 employable in a grill including any of the grills disclosed herein. As shown in FIG. 7, the removable unit 700 includes a vent 702 having a vent cover 704. The vent cover 704 is rotatable about an axis and relative to one or more openings (not shown) to adjust the amount of air flowing through the openings. For example, the openings may be defined by the vent 702, a faceplate 706 of the removable unit 700, etc.

As shown in FIG. 7, the vent 702 includes vent settings 708, 710, 712 that function substantially similar to the vent settings shown in FIGS. 1-4 and 6 and/or described above. For example, the vent settings 708, 710, 712 of FIG. 7 are designated with the colors yellow, orange, red, respectively, and with the words “SMOKE”, “GRILL” and “SEAR,” respectively, as explained above.

The vent settings 708, 710, 712 are aligned in an arc configuration that corresponds with the rotatable vent cover 704. For example, and as shown in FIG. 7, the vent 702 includes a knob 714 extending from the vent cover 704. The knob 714 can be manipulated to rotate the vent cover 704 to allow a user to select one of the different vent settings 708, 710, 712, as explained above. As shown, the knob 714 is crescent shaped, and includes an indicator 716 to notify a user which vent setting is selected, as explained above.

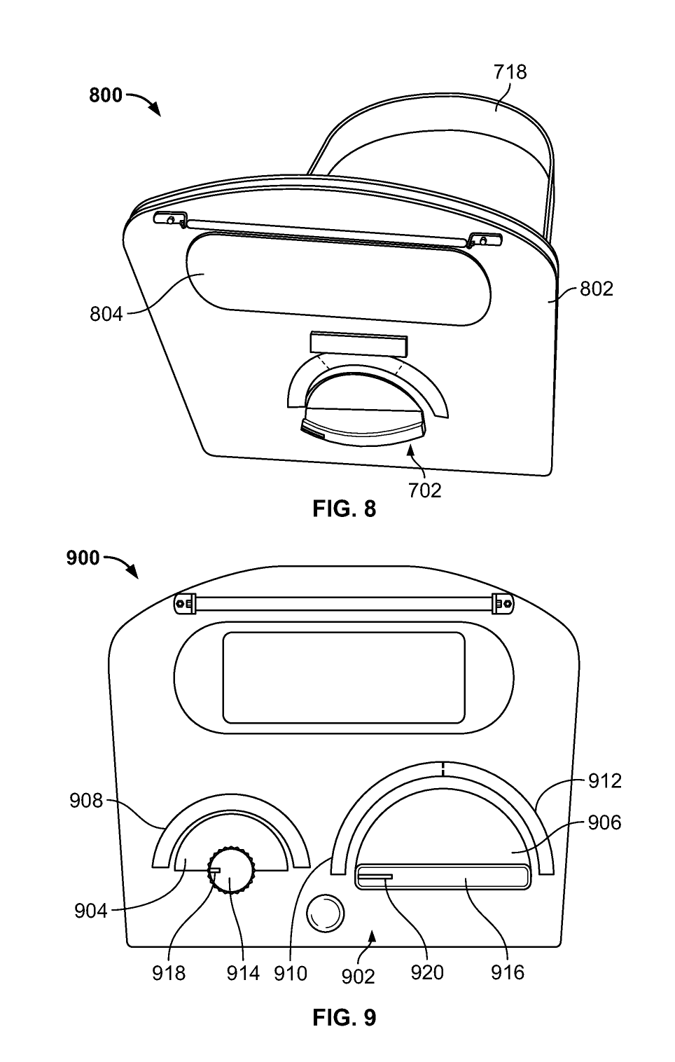

FIG. 8 illustrates another removable unit 800 employable in a grill including any of the grills disclosed herein. The removable unit 800 of FIG. 8 is substantially similar to the removable unit 700 of FIG. 7 but includes a port for receiving a fire starter device. For example, the removable unit 800 of FIG. 8 includes a faceplate 802, the vent 702 of FIG. 7, a port (not shown) extending between opposing surfaces of the faceplate 802, and an optional cover 804 for covering the port.

As shown in FIG. 8, the cover 804 is pivotally coupled to the faceplate 802 via a hinge. This allows a user to move the cover 804 between an open position in which the port is exposed and a closed position in which the port is covered. In some embodiments, the hinge may be spring loaded such that the cover 804 is forced back to its closed position once a user removes a manipulating force. Additionally and/or alternatively, gravity may force the cover 804 back to its closed position. Although the cover 804 includes a pivotal connection with the faceplate 802, it should be apparent that other suitable connections may be employed without departing from the scope of the disclosure.

FIG. 9 illustrates another removable unit 900 employable in a grill including any of the grills disclosed herein. The removable unit 900 of FIG. 9 is substantially similar to the removable units 700, 800 of FIGS. 7 and 8 but includes a vent 902 having two rotatable vent covers 904, 906 and three vent settings 908, 910, 912 that function substantially similar to the vent settings shown in FIGS. 1-4 and 6-8 and/or described above. For example, the vent settings 908, 910, 912 of FIG. 9 are designated with the colors yellow, orange, red, respectively, and with the words “SMOKE”, “GRILL” and “SEAR,” respectively, as explained above.

The vent settings 908, 910, 912 are aligned in two arc configurations that correspond with the rotatable vent covers 904, 906. For example, and as shown in FIG. 9, the vent setting 908 is adjacent to the vent cover 904, and the vent settings 910, 912 are to adjacent the vent cover 906.

Additionally, the vent 902 includes two knobs 914, 916 extending from the vent covers 904, 906, respectively. Each knob 914, 916 can be individually manipulated to rotate its respective vent cover 904, 906 to allow a user to select one of the different vent settings 908, 910, 912, as explained above. Similar to the knob 714 of FIG. 7, the knob 916 of FIG. 9 is crescent shaped, and includes an indicator 920 to notify a user which vent setting 910, 912 is selected. Likewise, the knob 914 is cylindrical shaped, and includes an indicator 918 to notify a user which particular position in the range of positions (as explained above) is selected.

The grills disclosed herein may include one or more other optional features including, for example, support structure(s), caster(s), fire bowl(s), vessel(s), lid(s), fastener(s), etc. For example, the grill 200 of FIGS. 2 includes a vessel 248 and a lid 246 coupled to the vessel 248 via one or more fasteners (e.g., hinge(s), etc.). In some examples, the lid 246 can be movable relative to the vessel 248 via the fasteners, and/or detachable from the vessel 248. Although not shown, the grill 200 may include a fire box positioned within the vessel 248. Additionally, the vessel 248, lid 246, etc. are supported by a support frame 242 and casters 244.

In the particular example of FIG. 2, the cooking chamber 202 includes the vessel 248, the lid 246, and the fire box. Alternatively, the cooking chamber 202 may include the vessel 248 and the lid 246.

The grills disclosed herein may be kamado-style grills. For example, the grill 200 of FIG. 2 is a kamado-style grill. As such, one or more components of these grills such as vessels, fire bowls, lids, etc. (if employed) may include one or more earthen materials. The earthen materials may include terracotta, high fire ceramics, cement rock compositions and/or other suitable ceramics, clays, etc. In some embodiments, the earthen materials do not include steel and/or other metallic materials. In other embodiments, the grills may be other types of grills such as grills including steel, etc.

Additionally, any suitable type of fuel may be used to generate heat in the grills. For example, any one or a combination of charcoal (e.g., natural lump charcoal, charcoal briquettes, etc.), wood, a flammable gas (e.g., propane, natural gas, etc.), etc. may be employed depending on, for example, user preference, cooking configuration(s), etc.

Additionally, the removable units disclosed herein may include one or more other optional features including, for example, one or more ash receptacles, fire starter openings, user input controls, vent covers, etc. For example, and as shown in FIGS. 7 and 8, the removable units 700, 800 each include a receptacle 718 for collecting ashes and/or other grilling byproduct (e.g., grease, debris, etc.). If desired, the removable units 700, 800 may be removed from their respective grill to dispose of the collected ashes and/or other grilling byproduct.

Further, although particular colors (e.g., yellow, orange and red) are used to designate different vent settings, it should be apparent that any suitable color may be employed including, for example, blue, green, purple, gold, white, black, etc. Likewise, although a particular number of vent settings are used in the vents disclosed herein, more or less vent settings may be employed if desired.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A grill assembly comprising:
a cooking chamber;
a first vent having a plurality of vent settings, each vent setting of the first vent corresponding to a different level of airflow in the cooking chamber, said each vent setting of the first vent designated with a color; and
a second vent having a plurality of vent settings, each vent setting of the second vent corresponding to a different level of airflow in the cooking chamber, said each vent setting of the second vent designated with a color,
wherein the grill assembly is adapted for one cooking configuration in response to the vent setting of the first vent and the vent setting of the second vent having a matching color and another cooking configuration in response to the vent setting of the first vent and the vent setting of the second vent having another matching color.

2. The grill assembly of claim 1 wherein said one cooking configuration is a first cooking configuration, said another cooking configuration is a second cooking configuration, said matching color is a first matching color, and said another matching color is a second matching color, and wherein the grill assembly is adapted for a third cooking configuration in response to the vent setting of the first vent and the vent setting of the second vent having a third matching color.

3. The grill assembly of claim 1 wherein said one cooking configuration includes at least one of a smoking configuration, a grilling configuration and a searing configuration.

4. The grill assembly of claim 1 wherein said each vent setting of the first vent is designated with one or more symbols.

5. The grill assembly of claim 4 wherein the one or more symbols include one or more words corresponding to said one cooking configuration and one or more words corresponding to said another cooking configuration.

6. The grill assembly of claim 1 wherein said matching color includes at least one of yellow, orange and red.

7. The grill assembly of claim 1 wherein the grill assembly includes a top side and a bottom side, wherein the first vent is positioned adjacent to the top side of the grill assembly, and wherein the second vent is positioned adjacent to the bottom side of the grill assembly.

8. The grill assembly of claim 1 wherein the grill assembly is a kamado-style grill.

9. The grill assembly of claim 1 wherein the first vent defines one or more openings and wherein the first vent includes at least one vent cover movable relative to the one or more openings to adjust the amount of air flowing through the openings.

10. The grill assembly of claim 9 wherein the at least one vent cover includes an indicator positionable adjacent to one of the plurality of vent settings of the first vent.

11. The grill assembly of claim 1 wherein the first vent includes a base and a label coupled to the base, and wherein the label includes the plurality of vent settings.

12. The grill assembly of claim 12 wherein the label is formed at least partially of rubber.

13. The grill assembly of claim 1 further comprising a removable unit insertable into the cooking chamber, the removable unit including the first vent.
